(19) United States
(12) Patent Application Publication
(10) Pub. No.: US 2002/0122483 A1
(43) Pub. Date: Sep. 5, 2002

(54) Encoding circuit and method

(75) Inventors: Yasushi Tanaka, Moriguchi-shi (JP); Masayuki Taniyama, Toyonaka-shi (JP)

Correspondence Address: PARKHURST & WENDEL, L.L.P., 1421 PRINCE STREET, SUITE 210, ALEXANDRIA, VA, 22314-2805, US

(73) Assignee: Matsushita Electric Industrial Co., Ltd., Kadoma-shi (JP)

(21) Appl. No.: 10/085,137

(22) Filed: Mar. 1, 2002

(30) Foreign Application Priority Data
Mar. 2, 2001 (JP) 2001-057749

(51) Int. Cl. H04N 7/12

(52) U.S. Cl. 375/240.03

(57) ABSTRACT

The present invention provides an encoding method and an encoding circuit, which consumes a reduced power at the variable length coding. This encoding circuit includes an EOB detector between a quantizer and an encoder, for detecting the rearmost non-zero quantized coefficients in a processing target block and outputting the position of the detected end as a control signal. The encoder performs a variable length coding process for the quantized coefficients up to the position indicated by the control signal, added an EOB code, and pauses the variable length coding process.

### FIELD OF THE INVENTION

The present invention relates to an encoding circuit of a digital signal recording/playback apparatus such as a video cassette recorder and a video disk recorder, which digitally records or plays back video or audio signals, and its encoding method. More particularly, this invention relates to an encoding circuit of a digital signal recording/playback apparatus that transmits or stores video or audio signals using a variable length coding process, and its encoding method.

### BACKGROUND OF THE INVENTION

To miniaturize a digital signal recording/playback apparatus, it is required to compress enormous amounts of information of digital video signals which are inputted to the apparatus, and record the same.

As methods for compressing (encoding) the digital video signals, there are a method employing motion compensation prediction, orthogonal transform, especially Discrete Cosine Transform (DCT), or band division, sampling by quantization, and further a method utilizing Variable Length Coding (VLC) such as Huffman coding, or arithmetic coding. The digital signal recording/playback apparatus transmits or stores digital video signals which are compressed by any of the above-mentioned compression methods.

Hereinafter, an encoding circuit of a prior art digital signal recording/playback apparatus will be described with reference to FIGS. 15, 13(a) and 13(b). FIG. 15 is a diagram illustrating a structure of the prior art encoding circuit. FIG. 13(a) is a diagram showing the data outputting order in a case where data in block units are scanned in the horizontal direction to be outputted, and FIG. 13(b) is a diagram showing the scanning order in a case where data in block units are diagonally scanned.

As shown in FIG. 15, the encoding circuit comprises a DCT unit 501, a quantizer 502, a memory 503, and an encoder 504. When data is inputted to the DCT unit 501, the DCT unit 501 performs a DCT process to the inputted data, and outputs DCT coefficients to the quantizer 502 in the latter stage. Then, the quantizer 502 quantizes the DCT coefficients, and outputs quantized coefficients to the memory 503 in the outputting order as shown in FIG. 13(a). The memory 503 is a single-port memory including two banks. When the quantized coefficients are stored by one block, the bank is automatically toggled and the stored quantized coefficients of one block are outputted to the encoder 504 in the latter stage as well as quantized coefficients of the next one block, which are successively transmitted, are stored.

The quantized coefficients of one block outputted from the memory 503 are diagonally scanned by the encoder 504 in block units as shown in FIG. 13(b) to rearrange the data, and thereafter the number of preceding quantized coefficients of zero (Run) and a value of a non-zero quantized coefficient (Level) are subjected to a two-dimensional variable length coding process together. Further, an EOB (End Of Block) code indicating the end of effective data in that block is added to the rearmost non-zero quantized coefficient in the block.

It is assumed here that the memory 503 is a single-port memory having two banks, but this memory may be constituted by a dual-port memory having one bank.

In the case where the prior art digital signal recording/playback apparatus has the structure as shown in FIG. 15, when the encoder 504 performs the two-dimensional variable length coding, the rearmost non-zero quantized coefficient in a block cannot be decided until the scanning in the diagonal direction is performed up to the end of this block. Accordingly, the power is consumed wastefully.

### SUMMARY OF THE INVENTION

The present invention has for its object to provide an encoding method and an encoding circuit, which consumes a reduced power when variable length coding or quantization is performed.

Other objects and advantages of the present invention will become apparent from the detailed description and specific embodiments described are provided only for illustration since various additions and modifications within the spirit and scope of the invention will be apparent to those of skill in the art from the detailed description.

According to a 1st aspect of the present invention, there is provided an encoding circuit which includes a frequency converter for frequency-converting data of a processing target block into frequency components, a quantizer for quantizing the frequency components, and an encoder for variable length coding the quantized frequency components in a predetermined scanning order, including: an EOB detector for detecting a position of a rearmost non-zero quantized frequency component in the processing target block in the predetermined scanning order, and outputting the detected position as a control signal to the encoder; and the encoder which variable length codes the quantized frequency components up to the position in the predetermined scanning order, indicated by the control signal, adds an EOB code that indicates an end of effective components, and pauses the variable length coding process. Therefore, before the encoder carries out the variable length coding process, the position in which the EOB code is inserted can be detected, and accordingly the variable length coding process can be paused from a quantized frequency component at the detected position till the last quantized frequency component in the processing target block. Consequently, the power consumption can be adaptively reduced without adversely decreasing the picture quality.

According to a 2nd aspect of the present invention, in the encoding circuit of the 1st aspect, the EOB detector is provided between a memory for temporarily retaining the quantized frequency components of the processing target block from the quantizer and outputting the retained frequency components in the predetermined scanning order, and the encoder, and the EOB detector includes: a counter for detecting a position of the quantized frequency component that is inputted from the memory; a comparator for comparing the quantized frequency component with zero; a buffer for storing values of the quantized frequency components; and a register for retaining a position of a non-zero quantized frequency component on the basis of a result of the comparator. Therefore, in the EOB detector, the position in which the EOB code is inserted in the processing target block can be detected and informed the encoder.

According to a 3rd aspect of the present invention, in the encoding circuit of the 1st aspect, the EOB detector is provided between the quantizer and a memory for temporarily retaining the quantized frequency components of the processing target block from the quantizer, and the EOB detector includes: a counter for detecting a position of the quantized frequency component that is inputted from the quantizer; a first comparator for comparing the quantized frequency component with zero; a buffer for storing values of the quantized frequency components; a conversion table for converting the value of the counter into an ordinal number of the quantized frequency component in the predetermined scanning order; a register for retaining a position of a non-zero quantized frequency component in the predetermined scanning order on the basis of a result of the first comparator; and a second comparator for comparing the position that is retained in the register, with the position of the rearmost non-zero quantized frequency component in the processing target block in the predetermined scanning order. Therefore, in the EOB detector, the position in which the EOB code is inserted in the processing target block can be detected and informed the encoder.

According to a 4th aspect of the present invention, in the encoding circuit of the 1st aspect, the EOB detector is provided between the frequency converter and the quantizer, and the EOB detector includes: a counter for detecting a position of a frequency component that is inputted from the frequency converter; a first comparator for comparing the frequency component, with a quantization value as a divisor for dividing the frequency component in the quantizer; a conversion table for converting the value of the counter into an ordinal number of the frequency component in the predetermined scanning order; a register for retaining a position of a non-zero quantized frequency component in the predetermined scanning order on the basis of a result of the first comparator; and a second comparator for comparing the position retained in the register, with the position of the rearmost non-zero quantized frequency component in the processing target block in the predetermined scanning order. Therefore, in the EOB detector, the position in which the EOB code is inserted in the processing target block can be detected and informed the encoder.

According to a 5th aspect of the present invention, there is provided an encoding circuit that includes a frequency converter for frequency-converting data of a processing target block into frequency components, a quantizer for quantizing the frequency components, and an encoder for variable length coding the quantized frequency components in a predetermined scanning order, comprising: an EOB detector for detecting a position of a rearmost non-zero quantized frequency component in the processing target block in the predetermined scanning order, and outputting the detected position as a control signal to the quantizer and the encoder; the quantizer quantizing the frequency components up to the position in the predetermined scanning order, indicated by the control signal, and pausing the quantization process; and the encoder variable length coding the quantized frequency components up to the position in the predetermined scanning order, indicated by the control signal, adding an EOB code that indicates an end of effective components, and pausing the variable length coding process. Therefore, before the quantizer performs the quantization, the position in which the EOB code is inserted can be detected, and the quantization process can be paused from a frequency component in the detection position till the last frequency component in the processing target and the variable length coding process can be paused from a quantized frequency component in the detected position till the last quantized frequency component in the processing target block. Consequently, the power consumption can be further reduced without adversely decreasing the picture quality.

According to a 6th aspect of the present invention, in the encoding circuit of the 5th aspect, the EOB detector is provided between the frequency converter and the quantizer, and the EOB detector includes: a memory for temporarily retaining the frequency components of the processing target block from the frequency converter, and outputting the retained frequency components in the predetermined scanning order; a counter for detecting a position of the frequency component that is inputted from the memory in the predetermined scanning order; a first comparator for comparing the frequency component, with a quantization value as a divisor for dividing the frequency component in the quantizer; a buffer for storing values of the frequency components; and a register for retaining a position of a non-zero quantized frequency component in the predetermined scanning order on the basis of a result of the first comparator. Therefore, in the EOB detector, the position in which the EOB code is inserted in the processing target block can be detected and informed the quantizer and the encoder.

According to a 7th aspect of the present invention, there is provided an encoding method comprising: a frequency conversion step of frequency-converting data of a processing target block into frequency components; a quantization step of quantizing the frequency components; an EOB detection step of judging whether the quantized frequency component is zero or not, and detecting a position of a rearmost non-zero quantized frequency component in the processing target block in a predetermined scanning order; and an encoding step of variable length coding the quantized frequency components up to the position in the predetermined scanning order, detected in the EOB detection step, adding an EOB code that indicates an end of effective components, and pausing the variable length coding process. Therefore, before the variable length coding process is carried out, the position in which the EOB code is inserted can be detected and the variable length coding process can be paused from a quantized frequency component in the detected position till the last quantized frequency component in the processing target block. Consequently, the power consumption can be adaptively reduced without adversely decreasing the picture quality.

According to an 8th aspect of the present invention, there is provided an encoding method comprising: a frequency conversion step of frequency-converting data of a processing target data into frequency components; an EOB detection step of comparing the frequency components with a quantization value as a divisor for dividing the frequency components in a quantization process, and detecting a position of a rearmost non-zero quantized frequency component in the processing target block in a predetermined scanning order; a quantization step of quantizing the frequency components; and an encoding step of variable length coding the quantized frequency components up to the position in the predetermined scanning order, detected in the EOB detection step, adding an EOB code that indicates an end of effective components, and pausing the variable length coding process. Therefore, before the variable length coding is performed, the position in which the EOB code is inserted can be detected and the variable length coding can be paused from a quantized frequency component in the detected position till the last quantized frequency component in the processing target block. Consequently, the power consumption can be adaptively reduced without adversely decreasing the picture quality.

According to a 9th aspect of the present invention, there is provided an encoding method comprising: a frequency conversion step of frequency-converting data of a processing target block into frequency components; an EOB detection step of comparing the frequency components with a quantization value as a divisor for dividing the frequency components in a quantization process, and detecting a position of a rearmost non-zero quantized frequency component in the processing target block in a predetermined scanning order; a quantization step of quantizing the frequency components up to the position in the predetermined order, detected in the EOB detection step, and pausing the quantization process; and an encoding step of variable length coding the quantized frequency components up to the position in the predetermined scanning order, adding an EOB code that indicates an end of effective components, and pausing the variable length coding process. Therefore, before the quantization is performed, the position in which the EOB code is inserted can be detected, and the quantization process can be paused from a frequency component in the detected position till the last frequency component in the processing target block and the variable length coding process can be paused from a quantized frequency component in the detected position till the last quantized frequency component in the processing target block. Consequently, the power consumption can be further reduced without adversely decreasing the picture quality.

According to a 10th aspect of the present invention, there is provided an encoding program for making a computer implement a process of frequency-converting data of a processing target block, quantizing frequency components, and variable length coding the quantized frequency components in a predetermined scanning order, and this process comprises: a frequency conversion step of frequency-converting the data of the processing target block into frequency components; a quantization step of quantizing the frequency components; an EOB detection step of judging whether the quantized frequency components are zero or not, and detecting a position of a rearmost non-zero quantized frequency component in the processing target block in the predetermined scanning order; and an encoding step of variable length coding the quantized frequency components up to the position in the predetermined scanning order, detected in the EOB detection step, adding an EOB code that indicates an end of effective components, and pausing the variable length coding process. Therefore, there can be provided a program that enables the power consumption to be adaptively reduced without adversely decreasing the picture quality in the process of frequency-converting the data of the processing target block, quantizing the data, and variable length coding the quantized frequency components in the predetermined scanning order.

According to an 11th aspect of the present invention, there is provided an encoding program for making a computer implement a process of frequency-converting data of a processing target block, quantizing frequency components, and variable length coding the quantized frequency components in a predetermined scanning order, and this process comprises: a frequency conversion step of frequency-converting the data of the processing target block into frequency components; an EOB detection step of comparing the frequency components with a quantization value as a divisor for dividing the frequency components in a quantization process, and detecting a position of a rearmost non-zero quantized frequency component in the processing target block in the predetermined scanning order; a quantization step of quantizing the frequency components; and an encoding step of variable length coding the quantized frequency components up to the position in the predetermined scanning order, detected in the EOB detection step, adding an EOB code that indicates an end of effective components, and pausing the variable length coding process. Therefore, there can be provided a program that enables the power consumption to be adaptively reduced without adversely decreasing the picture quality in the process of frequency-converting the data of the processing target block, quantizing the data, and variable length coding the quantized frequency components in the predetermined scanning order.

According to a 12th aspect of the present invention, there is provided an encoding program for making a computer implement a process of frequency-converting data of a processing target block, quantizing frequency components, and variable length coding the quantized frequency components in a predetermined scanning order, and this process comprises: a frequency conversion step of frequency-converting the data of the processing target block into frequency components; an EOB detection step of comparing the frequency components with a quantization value as a divisor for dividing the frequency components in a quantization process, and detecting a position of a rearmost non-zero quantized frequency component in the processing target block in the predetermined scanning order; a quantization step of quantizing the frequency components up to the position in the predetermined scanning order, detected in the EOB detection step, and pausing the quantization process; and an encoding step of variable length coding the quantized frequency components up to the position in the predetermined scanning order, adding an EOB code that indicates an end of effective components, and pausing the variable length coding process. Therefore, there canbe provided a program that enables the power consumption to be adaptively reduced without adversely decreasing the picture quality in the process of frequency-converting the data of the processing target block, quantizing the data, and variable length coding the quantized frequency components in the predetermined scanning order.

### BRIEF DESCRIPTION OF THE DRAWINGS

FIG. 1 is a block diagram illustrating a structure of an encoding circuit according to a first embodiment of the present invention.

FIG. 2 is a block diagram illustrating a specific structure of an EOB detector in the encoding circuit according to the first embodiment.

FIG. 3 is a flowchart for explaining a sequential operation of the encoding circuit according to the first embodiment.

FIG. 4 is a block diagram illustrating a structure of an encoding circuit according to a second embodiment of the present invention.

FIG. 5 is a block diagram illustrating a specific structure of an EOB detector in the encoding circuit according to the second embodiment.

FIG. 6 is a flowchart for explaining a sequential operation of the encoding circuit according to the second embodiment.

FIG. 7 is a block diagram illustrating a structure of an encoding circuit according to a third embodiment of the present invention.

FIG. 8 is a block diagram illustrating a specific structure of an EOB detector in the encoding circuit according to the third embodiment.

FIG. 9 is a flowchart for explaining a sequential operation of the encoding circuit according to the third embodiment.

FIG. 10 is a block diagram illustrating a structure of an encoding circuit according to a fourth embodiment of the present invention.

FIG. 11 is a block diagram illustrating a specific structure of an EOB detector in the encoding circuit according to the fourth embodiment.

FIG. 12 is a flowchart for explaining a sequential operation of the encoding circuit according to the fourth embodiment.

FIG. 13(a) is a diagram showing the data outputting order in a case where data in block units are scanned in the horizontal direction, FIG. 13(b) is a diagram showing the order in a case where the data in block units are diagonally scanned, and FIG. 13(c) is a diagram showing the data processing order, the order in which the corresponding data is diagonally scanned, DCT coefficients, and values retained in a register at that time.

FIG. 14 is a diagram showing a state where data is written in a memory and a state where the data is rearranged and read out from the memory, according to the embodiments of the present invention.

FIG. 15 is a block diagram illustrating a structure of the prior art encoding circuit.

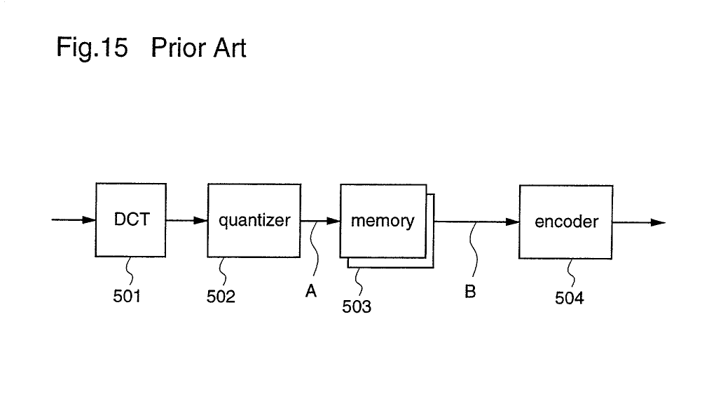

### DETAILED DESCRIPTION OF THE PREFERRED EMBODIMENTS

Embodiments according to the present invention will be described with reference to the drawings.

[Embodiment 1]

Hereinafter, an encoding circuit according to a first embodiment of the present invention is described with reference to figures.

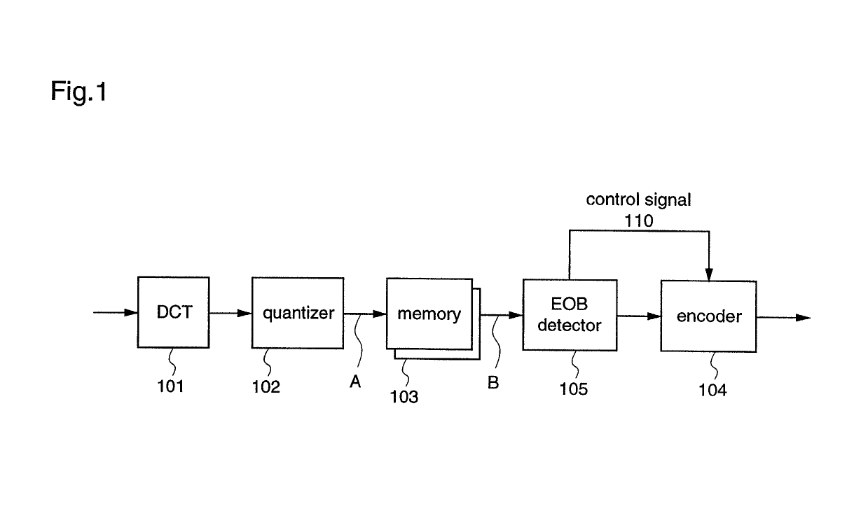

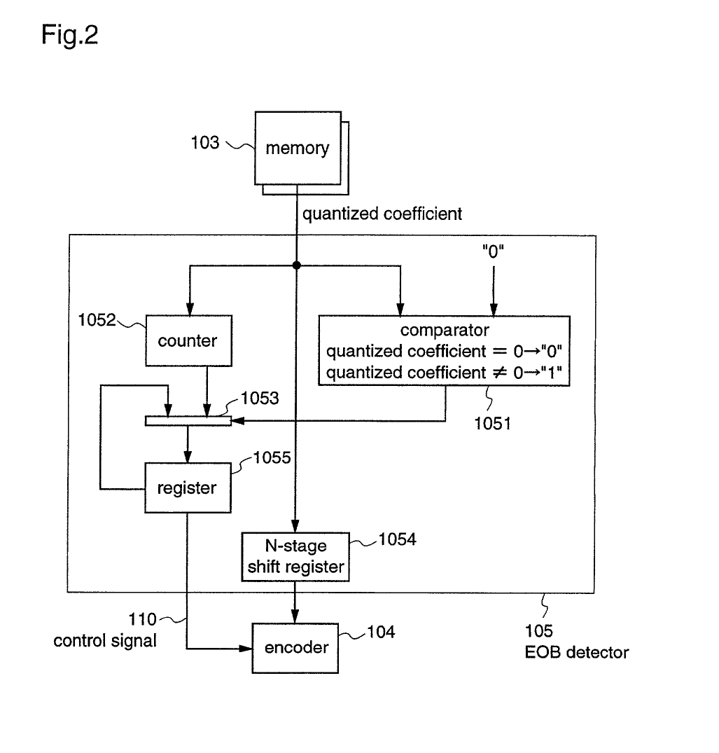

FIG. 1 is a block diagram illustrating a structure of the encoding circuit according to the first embodiment. FIG. 2 is a block diagram illustrating a specific structure of an EOB detector in FIG. 1.

As shown in FIG. 1, the encoding circuit of the first embodiment comprises a DCT unit 101 for subjecting data to a DCT process, a quantizer 102 for quantizing data from the DCT unit 101, a memory 103 for temporarily retaining data from the quantizer 102 and scanning the retained data diagonally to be outputted, an EOB detector 105 for detecting the position of a rearmost non-zero value in a processing target block and outputting the detected position as a control signal 110, and an encoder 104 for performing variable length coding.

The EOB detector 105 of the first embodiment comprises, as shown in FIG. 2, a comparator 1051 for checking whether the inputted data is zero or not, a counter 1052 for counting inputted data to know where the inputted data is from the top, a selector 1053 for selecting a value to be held by a register 1055 on the basis of a result of the comparator 1051, and an N-stage shift register 1054 for retaining data inputted from the memory 103 by one block.

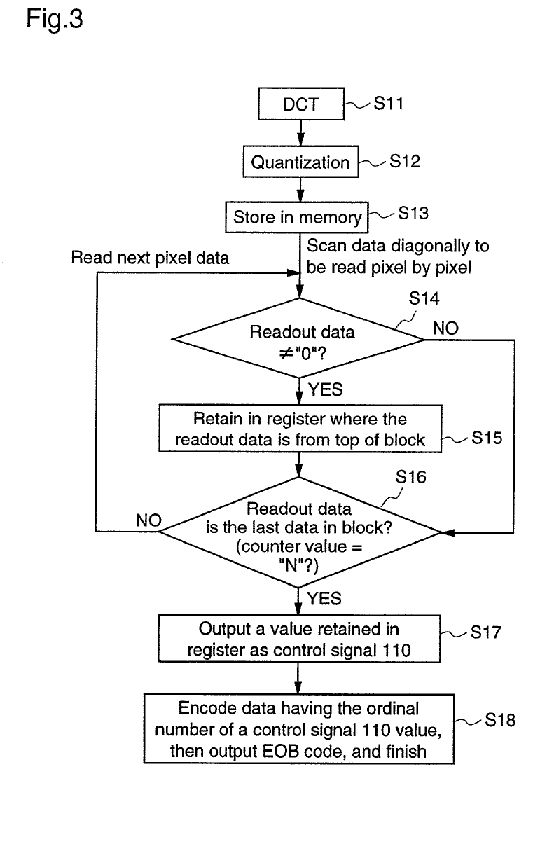

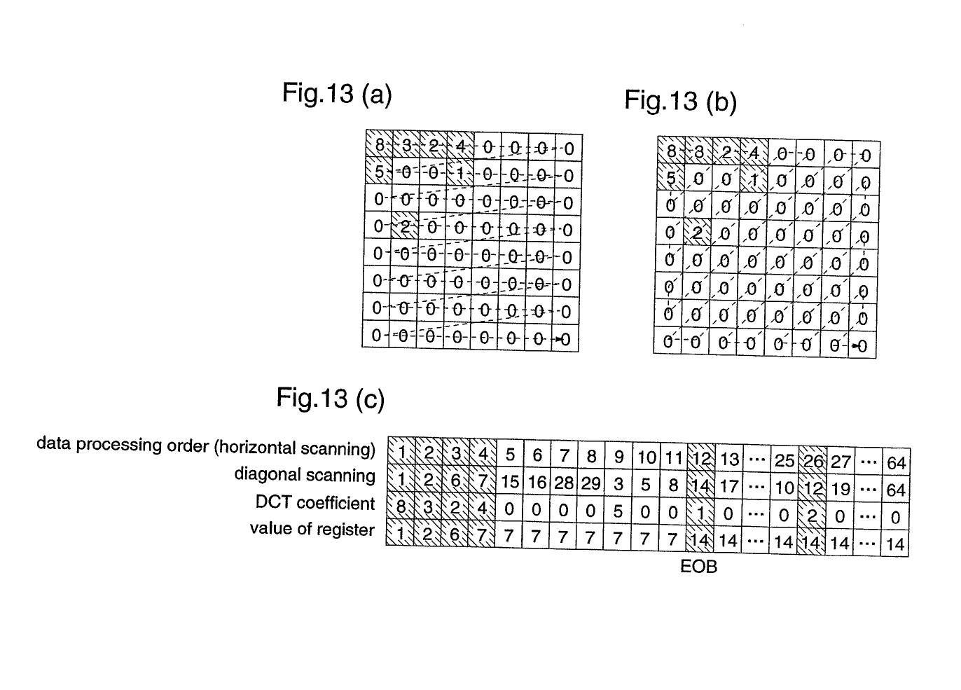

Next, the operation of the encoding circuit of the first embodiment will be described with reference to FIGS. 3, 13(a), 13(b) and 14. FIG. 3 is a flowchart for explaining a sequential operation of the encoding circuit according to the first embodiment. FIG. 13(a) is a diagram showing an example where data of one block is successively scanned in the horizontal direction to be outputted. FIG. 13(b) is a diagram showing an example where data of one block is successively scanned diagonally.

It is assumed here that the data that is inputted to the encoding circuit is a digital video signal in which one block is composed of N pixels.

Initially, the data inputted to the encoding circuit is converted into DCT coefficients by the DCT unit 101 (step S11). Then, the DCT coefficients which are scanned in the horizontal direction as shown by an arrow in FIG. 13(a) and outputted from the DCT unit 101 (A in FIG. 1) are quantized by the quantizer 102 (step S12), and then stored in the memory 103 (step S13).

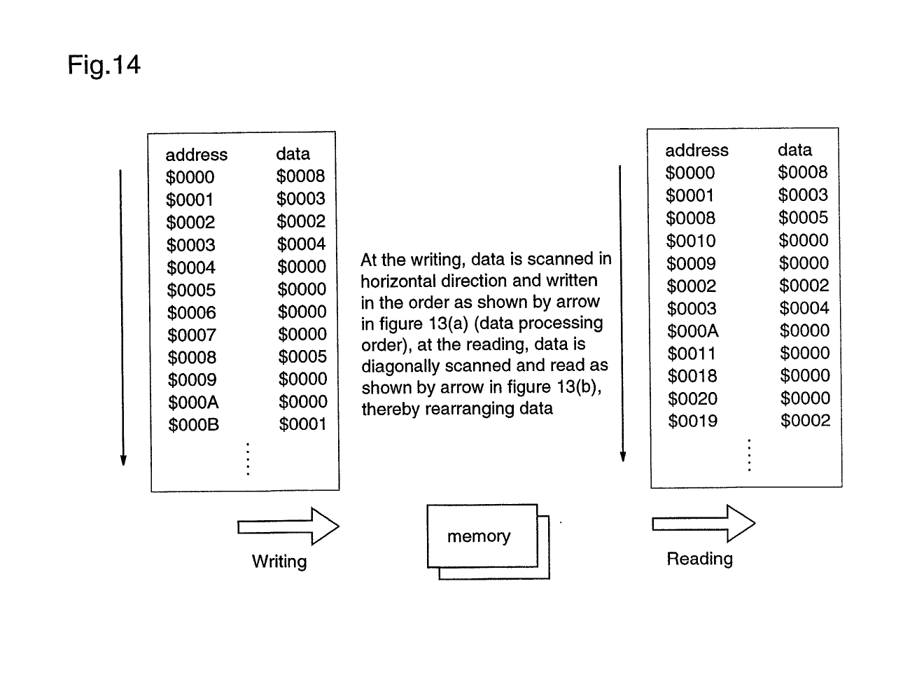

The memory 103 is a single-port memory having two banks. When the coefficients quantized by the quantizer 102 are stored therein by one block, the bank switching is performed and the quantized coefficients of the next block that is successively inputted are stored in the switched bank. Simultaneously, the quantized coefficients of one block (B in FIG. 1), stored in the memory 103, are diagonally scanned as shown by an arrow in FIG. 13(b), and inputted to the EOB detector 105. The states of the memory 103 in which data is written and from which data is read are shown in FIG. 14.

In the EOB detector 105, the data read from the memory 103 is initially inputted to the counter 1052, the comparator 1051, and the N-stage shift register 1054. Then, the counter 1052 counts inputted data to know where the readout data is from the top of the processing target block. The comparator 1051 checks whether the value of the data that is read from the memory 103 pixel by pixel is zero or not (step S14), and outputs an obtained result to the selector 1053. The N-stage shift register 1054 retains the readout data.

When the comparator 1051 judges that the readout data is zero (when the comparator 1051 outputs “0”), the selector 1053 selects a value that is retained in the register 1055. On the other hand, when the comparator 1051 judges that the readout data is non-zero (when the comparator 1051 outputs “1”) the selector 1053 selects the present value of the counter 1052, and the selected value is retained in the register 1055 (step S15).

To be more specific, in this first embodiment, because the quantized coefficients are diagonally scanned to be read out from the memory 103 and inputted to the EOB detector 105, when a value of the counter 1052 is inputted to the register 1055, the value of the counter 1052 indicates the ordinal number of the readout data from the top of the block when the data is diagonally scanned. Accordingly, the position of the rearmost non-zero quantized coefficient in the block can be informed the encoder 104 that scans data diagonally to perform variable length coding.

Since it is assumed here that one block is composed of N pixels, whether or not the readout data is the last data in the processing target block is judged on the basis of whether the value of the counter 1052 is N or not (step S16). When the readout data is not the last data (when the counter 1052 value≠N), the operation is returned to step S14 and the above-mentioned processes are repeated. When the readout data is the last data in the block (when the counter 1052 value=N), a value that is retained at that time in the register 1055 is outputted to the encoder 104 as the control signal 110 (step S17). Simultaneously, the quantized coefficients of one block stored in the N-stage shift register 1054 are outputted to the encoder 104 (step S17). At the same time, the values of the counter 1052 and the register 1055 are set at 1 to be initialized.

The encoder 104 variable length codes the quantized coefficients of one block outputted from the EOB detector 105. At that time, the position of a rearmost non-zero quantized coefficient in the block is detected on the basis of the control signal 110 outputted from the EOB detector 105, a variable length coding process is carried out for quantized coefficients up to the detected position, an EOB (End Of Block) code is added after the variable length coding process for the rearmost non-zero quantized coefficient, and the operation of the encoder 104 is paused until the next block data is inputted from the EOB detector 105 (step S18). When doing so, the encoder 104 is not required to perform the variable length coding for all data in one block, thereby reducing the power consumed by the coding circuit.

As described above, the encoding circuit according to the first embodiment includes the EOB detector 105 between the memory 103 and the encoder 104. Then, the EOB detector 105 detects the rearmost non-zero quantized coefficient in a processing target block, and outputs a value indicates where the rearmost non-zero quantized coefficient is from the top of the block in the case where the data is diagonally scanned, to the encoder 104 as the control signal 110. When the position of the rearmost non-zero quantized coefficient is detected on the basis of the control signal 110, the encoder 104 carries out the variable length coding process for quantized coefficients up to the detected position, adds an EOB code to the rearmost non-zero quantized coefficient, and pauses its operation until quantized data of the next block is inputted from the EOB detector 105. Therefore, the consumed power at the variable length coding in the encoder 104 can be reduced, and consequently the consumed power in the encoding circuit can be reduced without adversely affecting the picture quality.

In this first embodiment, the memory 103 is a single-port memory having two banks, but the memory 103 may be a dual-port memory having one bank.

In this first embodiment, the descriptions have been given taking the DCT process as an example of the method for frequency-converting data that is inputted to the encoding circuit, while any method can be employed as long as the frequency conversion is performed for data that is inputted to the encoding circuit. Further, in this first embodiment, when the data after the DCT process is to be quantized, the data is diagonally scanned, while the data can be scanned in any order and the scanning order may be decided according to the properties of data that is inputted to this encoding circuit.

[Embodiment 2]

Hereinafter, an encoding circuit according to a second embodiment of the present invention will be described with reference to figures.

In the first embodiment, the EOB detector 105 is provided between the memory 103 and the encoder 104, while in this second embodiment, the EOB detector is provided between the quantizer and the memory.

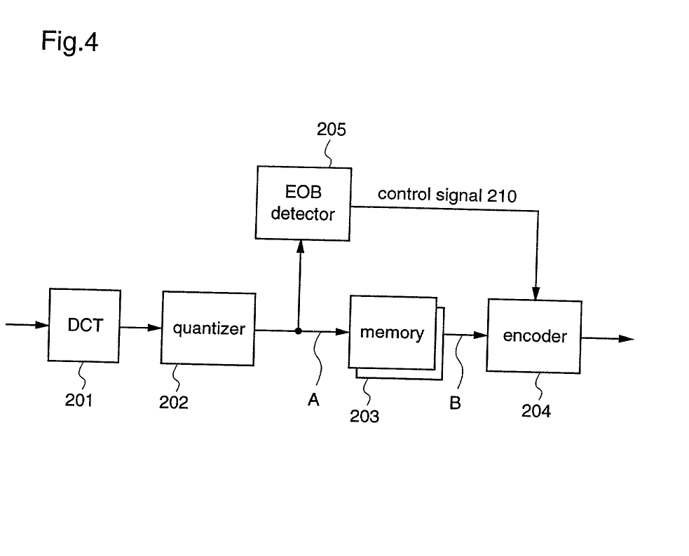

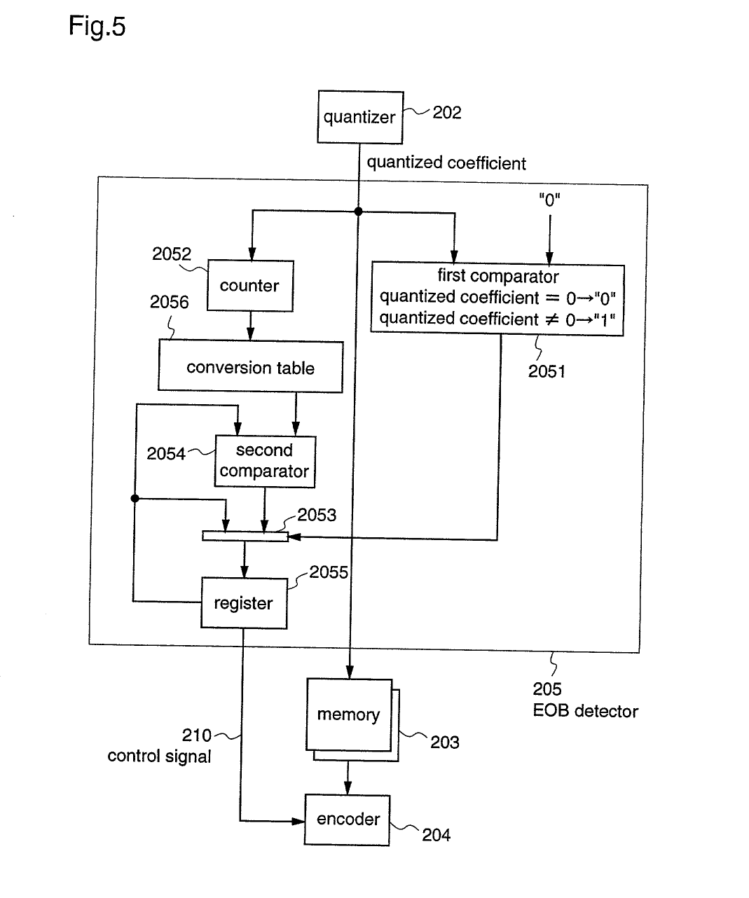

Initially, the structure of the encoding circuit according to the second embodiment is described with reference to FIGS. 4 and 5.

FIG. 4 is a block diagram illustrating the structure of the encoding circuit of the second embodiment. FIG. 5 is a block diagram illustrating a specific structure of an EOB detector shown in FIG. 4.

As shown in FIG. 4, the encoding circuit of the second embodiment comprises a DCT unit 201 for carrying out a DCT process for inputted data, a quantizer 202 for quantizing data from the DCT unit 201, an EOB detector 205 for detecting the position of a rearmost non-zero value in a processing target block and outputting the detected position as a control signal 220, a memory 203 for temporarily retaining data from the quantizer 202 and diagonally scanning the retained data to be outputted, and an encoder 204 for performing variable length coding.

The EOB detector 205 of the second embodiment comprises, as shown in FIG. 5, a first comparator 2051 for checking whether the inputted data is zero or not, a counter 2052 for counting data to know where the inputted data is from the top of the processing target block, a conversion table 2056 for converting the ordinal number of data from the top when the data is scanned in the horizontal direction, into the ordinal number of the corresponding data from the top when the data is diagonally scanned, a second comparator 2054 for selecting a larger value from inputted values, and a selector 2053 for selecting a value that is to be retained in a register 2055 according to the result of the first comparator 2051.

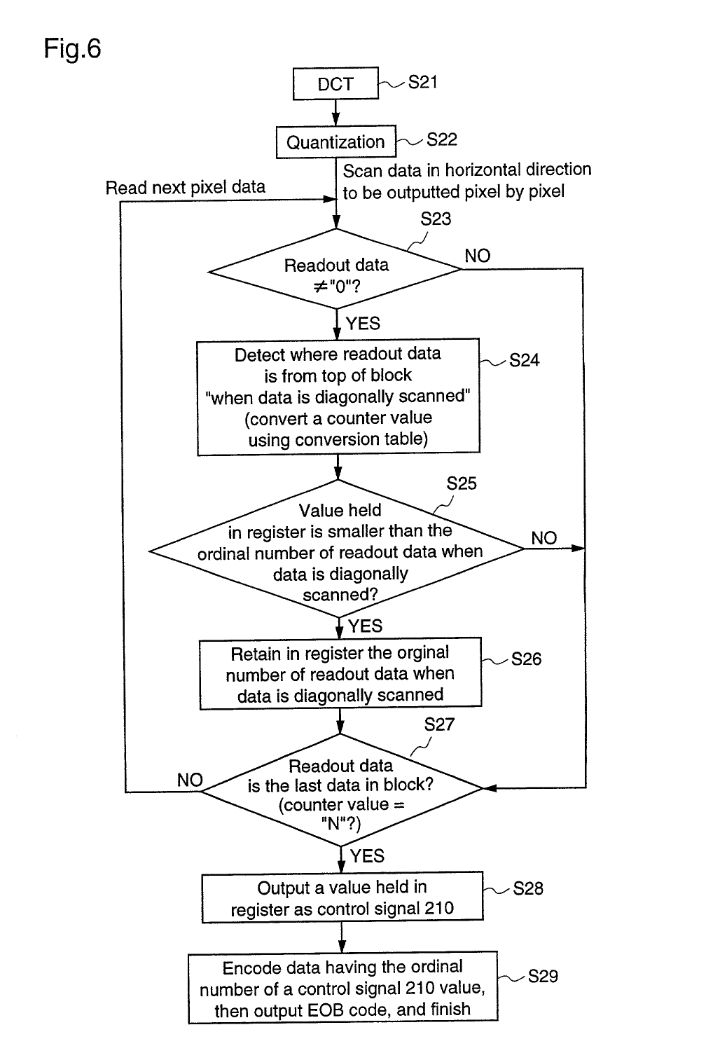

Next, with reference to FIGS. 6 and 13(c), the operation of the encoding circuit according to the second embodiment will be described. FIG. 6 is a flowchart for explaining the sequential operation of the encoding circuit according to the second embodiment. FIG. 13(c) is a table showing the order in which data is processed, the order in which the corresponding data is diagonally scanned, DCT coefficients, and values presently held in the register.

Here, the data that is inputted to the encoding circuit is a digital video signal in which one block is composed of N pixels. The conversion table 2056 is, for example, one as shown by upper two rows in FIG. 13(c), and converts the ordinal number of data from the top: for example, converts the third data from the top in a case where data is scanned in the horizontal direction, into the sixth data from the top in a case where the data is diagonally scanned.

Initially, the data inputted to the encoding circuit is converted into DCT coefficients by the DCT unit 201 (step S21). Then, the DCT coefficients are scanned in the horizontal direction in the order as shown by the arrow in FIG. 13(a) to be outputted from the DCT unit 201, quantized by the quantizer 202 (step S22), and outputted to the EOB detector 205 and the memory 203 in the same order as the order in which the data is outputted from the DCT unit 201 (A in FIG. 4).

The memory 203 is a single-port memory having two banks. Quantized coefficients of one block, quantized by the quantizer 202, are stored in one bank, thereafter the banks are switched, and data is successively stored.

In the EOB detector 205, the data that is read from the quantizer 202 is outputted to the counter 2052 and the first comparator 2051. The counter 2052 counts data to know where the readout data is from the top of the processing target block. The first comparator 2051 checks whether the value of data that is read pixel by pixel from the quantizer 202 is zero or not (step S23), and outputs an obtained result to the selector 2053.

When the first comparator 2051 judges that the readout data is zero (when the first comparator 2051 outputs “0”), the selector 2053 selects a value that is held in the register 2055. On the other hand, when the first comparator 2051 judges that the readout data is non-zero (when the first comparator 2051 outputs “1”), the value of the counter 2052 at that time is converted into the ordinal number of the data when the data is diagonally scanned, by using the conversion table 2056 (step S24). The second comparator 2054 compares the obtained ordinal number with the value that is retained in the register 2055 to select a larger value (step S25), and the value selected at that time by the second comparator 2054 is retained in the register 2055 (step S26).

To be more specific, in this second embodiment, the quantized coefficients are scanned in the horizontal direction as shown in FIG. 13(a) to be outputted from the quantizer 202. Thus, the value of the counter 2052 indicates the ordinal number of the readout data from the top of the block when the data is scanned in the horizontal direction. On the other hand, in the encoder 204, data of one block are diagonally scanned as shown in FIG. 13(b) and subjected to the variable length coding process. Therefore, in order to inform the encoder 204 of the position of the rearmost non-zero quantized coefficient in the block, the value of the counter 2052 should be converted into the ordinal number of the corresponding data when the data is scanned diagonally.

Accordingly, when the data read out from the quantizer 202 is judged by the first comparator 2051 to be non-zero, the value of the counter 2052 is converted into the ordinal number when the data is diagonally scanned, using the conversion table 2056. Further, since there are some cases where a value that is read out earlier in the case of diagonal scanning is read out later in the case of horizontal scanning, because of the difference in the order of scanning for blocks between the diagonal scanning and the horizontal scanning, the second comparator 2054 compares a value retained in the register 2055 with the value converted by the conversion table 2056 to select a larger value, and the selected value is stored in the register 2055. Accordingly, the encoder 204 that scans data diagonally to perform variable length coding can detect the position of the rearmost non-zero quantized coefficient in the block.

Then, whether the readout data is the last data in the processing target block or not is judged on the basis of whether the counter 2052 value is N or not (step S27) because one block is composed of N pixels. When the readout data is not the last data (when the register 2055 value≠N), the operation is returned to step S233 and the above-mentioned processes are repeated. On the other hand, when the readout data is the last data in the block (the register 2055 value=N), a value that is presently held in the register 2055 is outputted to the encoder 204 as the control signal 210 (step S28). Simultaneously, the values of the counter 2052 and the register 2055 are set at 1 to be initialized.

When the memory 203 retains data of one block from the quantizer 202, bank switching is performed to store quantized coefficients of next block data which are successively inputted, while the stored quantized coefficients of one block are diagonally read as shown by the arrow in FIG. 13(b), and outputted to the encoder 204 (B in FIG. 4). The states of data that is written in the memory 203 and data that is read from the memory are shown in FIG. 14.

The encoder 204 variable length codes the quantized coefficients of one block, which are outputted from the memory 203. At that time, the position of the rearmost non-zero quantized coefficient in the block is detected on the basis of the control signal 210 that is outputted from the EOB detector 205, the variable length coding is performed for the quantized coefficients up to the detected position, an EOB code is added to the last value which has been subjected to the variable length coding, and then the encoder 204 is paused until the next block data is inputted from the EOB detector 205 (step S29). When doing so, the encoder 204 is not required to carry out the variable length coding for all data in one block, thereby reducing the power that is consumed by the encoding circuit.

As described above, the encoding circuit according to the second embodiment comprises the EOB detector 205 between the quantizer 202 and the memory 203. The EOB detector 205 detects the position of the rearmost non-zero quantized coefficient in a processing target block in the case of diagonal scanning, and outputs the detected value to the encoder 204 as the control signal 210. When the position of the rearmost non-zero quantized coefficient is detected on the basis of the control signal 210, the encoder 204 performs the variable length coding for quantized coefficients up to the detected position, adds an EOB code to the rearmost non-zero quantized coefficient, and pauses its operation until quantized data of the next block is inputted from the quantizer 202. Therefore, the power that is consumed by the encoder 204 when the variable length coding is performed can be reduced, and consequently the consumed power can be reduced in the encoding circuit without adversely affecting the picture quality.

In this second embodiment, the memory 203 is a single-port memory having two banks, while the memory 203 may be a dual-port memory having one bank.

In this second embodiment, the descriptions have been given taking the DCT process as an example of the method for frequency-converting data that is inputted to the encoder, while any method can be used as long as the data that is inputted to the encoding circuit is frequency-converted. Further, the descriptions have been given taking a case where the scanning is performed diagonally when the encoder 204 performs the variable length coding. However, any scanning order may be employed and the scanning order can be selected according to the properties of data that is inputted to the encoder. In this case, the conversion table 2056 in the EOB detector 205 should be changed to a table for converting a value of the counter 2052 (the data processing order) into the scanning order according to the data properties.

[Embodiment 3]

Hereinafter, an encoding circuit according to a third embodiment of the present invention will be described with reference to figures.

In this third embodiment, descriptions are given of a case where an EOB detector is provided between a DCT unit and a quantizer.

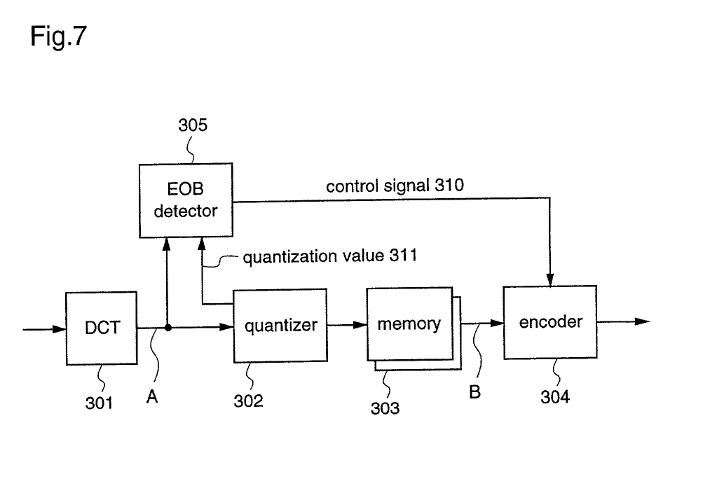

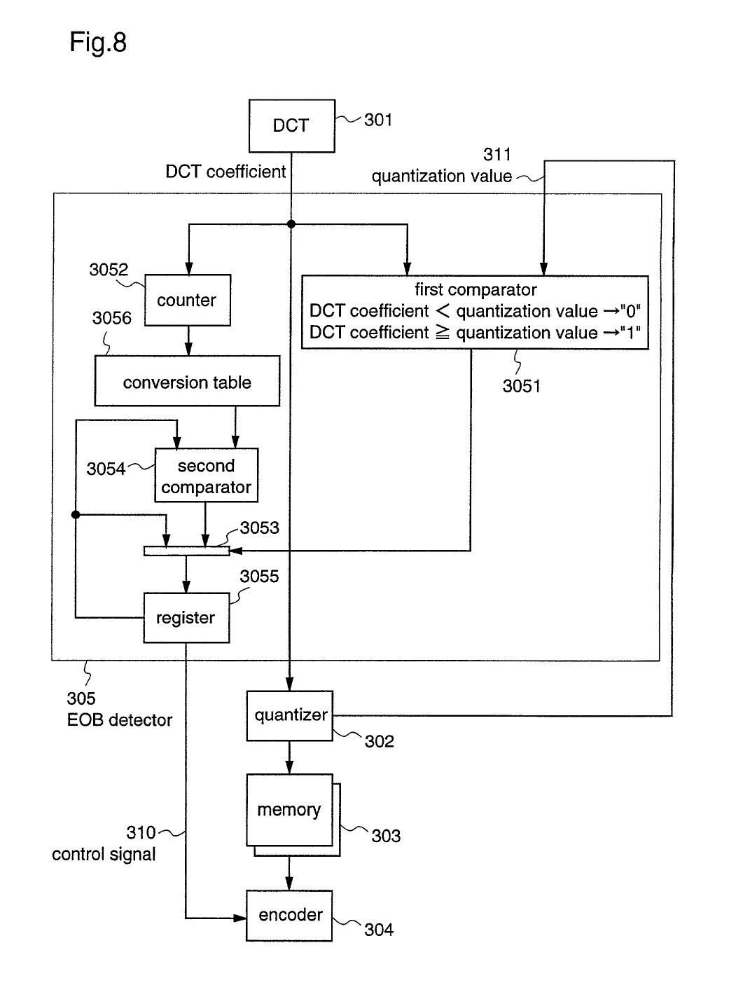

Initially, with reference to FIGS. 7 and 8, a structure of the encoding circuit according to the third embodiment will be described.

FIG. 7 is a block diagram illustrating the structure of the encoding circuit according to the third embodiment. FIG. 8 is a diagram illustrating a specific structure of an EOB detector in FIG. 7.

As shown in FIG. 7, the encoding circuit according to the third embodiment comprises a DCT unit 301 for subjecting inputted data to a DCT process, an EOB detector 305 for outputting the position of the rearmost non-zero value in a processing target block as a control signal 310, a quantizer 302 for quantizing data from the DCT unit 301, a memory 303 for temporarily retaining data from the quantizer 302 and scanning the retained data diagonally to be outputted, and an encoder 304 for performing variable length coding.

The EOB detector 305 according to the third embodiment comprises, as shown in FIG. 8, a first comparator 3051 for comparing the data read from the DCT unit 301 with a quantization value 311 as a divisor that is used when the readout data is quantized by the quantizer 302; a counter 3052 for counting data to know where the readout data is from the top of the processing target block; a conversion table 3056 for converting the ordinal number of data from the top when the data is scanned in the horizontal direction to be outputted, into the ordinal number of the corresponding data from the top when the data is diagonally scanned; a second comparator 3054 for comparing inputted values to select a larger value; and a selector 3053 for selecting a value that is to be held in the register 3055 on the basis of the result of the first comparator 3051.

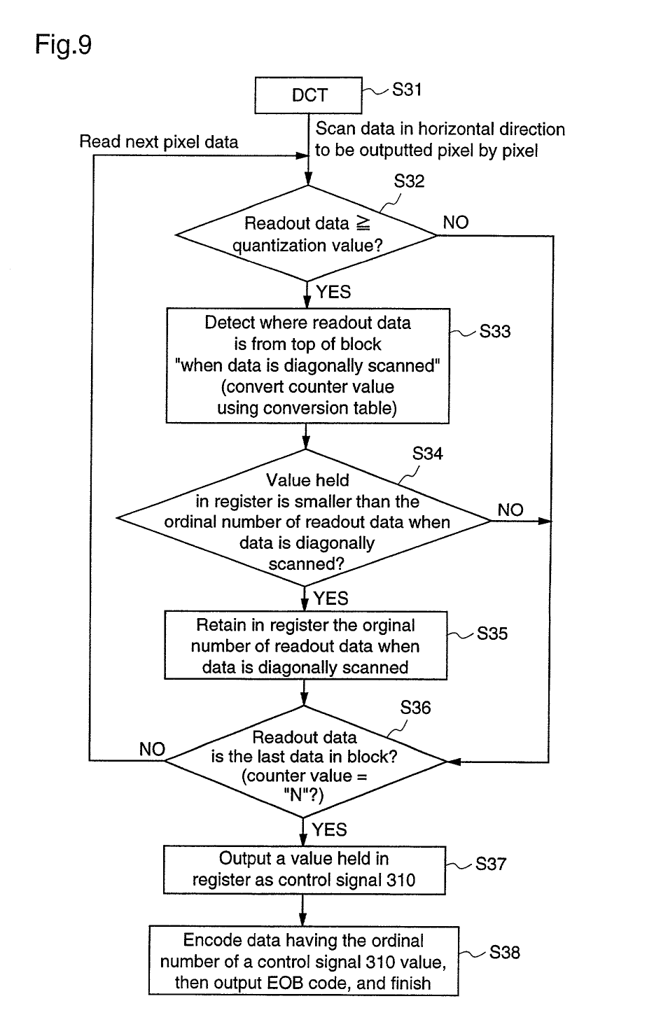

Next, the operation of the encoding circuit according to the third embodiment will be described with reference to FIG. 9. FIG. 9 is a flowchart for explaining the sequential operation of the encoding circuit according to the third embodiment.

It is assumed here that the data that is inputted to the encoding circuit is a digital video signal in which one block is composed of N pixels. The conversion table 3056 is, for example, the one as shown by the upper two rows in FIG. 13(c), and converts the ordinal number of data from the top: for example, converts the third data from the top in the case of horizontal scanning into the sixth data from the top in the case of diagonal scanning.

Initially, the data that is inputted to the encoding circuit is converted by the DCT unit 301 into DCT coefficients (step S31). Then, the DCT coefficients are scanned in the horizontal direction as shown by the arrow in FIG. 13(a) to be outputted from the DCT unit 301, and inputted to the EOB detector 305 and the quantizer 302 (A in FIG. 7).

In the EOB detector 305, the data that is read from the DCT unit 301 is initially inputted to the counter 3052 and the first comparator 3051. The counter 3052 counts data to know where the readout data is from the top of the processing target block. The first comparator 3051 checks whether a value of data that is read from the DCT unit 301 pixel by pixel is equal to or larger than the quantization value 311 as a divisor for dividing the data in the quantization process (step S32), and outputs an obtained result to the selector 3053.

The reason why the first comparator 3051 compares the readout data with the quantization value 311 is as follows. The quantization value 311 corresponds to a divisor for dividing the readout data in the quantization process for the data. Therefore, when the value of the readout data is larger than the quantization value 311, it can be judged when the data is quantized by the quantizer 302 in the latter stage and inputted to the encoder 304 that the readout data is non-zero.

When it is judged by the first comparator 3051 that the readout data is smaller than the quantization value 311 (when the first comparator 3051 outputs “0”), the selector 3053 selects a value that is held in the register 3055. On the other hand, when it is judged by the first comparator 3051 that the readout data is equal to or larger than the quantization value 311 (when the first comparator 3051 outputs “1”), a value of the counter 3052 at that time is converted into the ordinal number of the data when the data is diagonally scanned, by using the conversion table 3056 (step S33). Then, the second comparator 3054 compares the obtained ordinal number of the data in the case of the diagonal scanning with the value that is held in the register 3055, and selects a larger one (step S34). The value selected by the second comparator 3054 is retained in the register 3055 (step S35).

According to the third embodiment, the DCT coefficients are scanned in the horizontal direction as shown by the arrow in FIG. 13(a), to be outputted from the DCT unit 301. Therefore, the value of the counter 3052 indicates the ordinal number of the readout data from the top of the block when the data is scanned in the horizontal direction. However, in the encoder 304, data of one block is diagonally scanned as shown by the arrow in FIG. 13(b) to perform the variable length coding process. Therefore, in order to inform the encoder 304 of the position of the rearmost non-zero quantized coefficient in the block, the value of the counter 3052 should be converted into the ordinal number of the data in a case where the data are diagonally scanned. In this third embodiment, when it is judged by the first comparator 3051 that the readout data is equal to or larger than the quantization value 311, the value of the counter 3052 at that time is converted to the ordinal number of the data in a case where the data is scanned diagonally, using the conversion table 3056. Further, since there are some cases where a value that is read out earlier in the case of diagonal scanning is read out later in the case of horizontal scanning, due to the difference in the scanning order for the block between the diagonal scanning and the horizontal scanning, the second comparator 3054 compares the value held in the register 3055 with the value obtained by the conversion table 3056 to select a larger one, and stores the selected value in the register 3055.

Thus, a DCT coefficient that is judged by the first comparator 3051 to be equal to or larger than the quantization value 311 is detected, the position of the DCT coefficient in the processing target block in the case of horizontal scanning is detected by the counter 3052, the ordinal number of the data in the case of horizontal scanning is converted into the ordinal number in the case of the diagonal scanning, using the conversion table 3056. Further, the second comparator 3054 always makes a larger value to be held in the register 3055. Therefore, the encoder 304 that scans data diagonally to perform variable length coding can detect the position of the rearmost non-zero quantized coefficient in the block.

Then, whether or not the readout data is the last data in the processing target block is judged on the basis of whether the value of the counter 3052 is N or not (step S36), because one block is composed of N pixels. When the readout data is not the last data (when the register 3055 value≠N), the operation is returned to step S32 and the above-mentioned processes are repeated. When the readout data is the last data (when the register 3055 value =N), the value that is presently held in the register 3055 is outputted to the encoder 304 as the control signal 310 (step S37). Simultaneously, the values of the counter 3052 and the register 3055 are set at 1 to be initialized.

Then, the DCT coefficients outputted from the DCT unit 301 are inputted to the quantizer 302 pixel by pixel to be quantized, and stored in the memory 303.

This memory 303 is a single-port memory having two banks. After quantized coefficients of one block which have been quantized by the quantizer 302 are stored in one bank, the bank switching is performed, and quantized coefficients of the next block data that is successively inputted are stored while the stored quantized coefficients of one block are read diagonally as shown by the arrow in FIG. 13(b) and outputted to the encoder 304 (B in FIG. 7). The state where data is written in the memory 303 and the state where the data is read from the memory are shown in FIG. 14.

The encoder 304 carries out the variable length coding for the quantized coefficients of one block that is outputted from the memory 303. At that time, the position of the rearmost non-zero quantized coefficient in the block is detected on the basis of the control signal 310 that is outputted from the EOB detector 305, the variable length coding is carried out for the quantized coefficients up to the detected position, an EOB code is added to the last value which has been subjected to the variable length coding, and the encoder 304 is paused until the next block data is inputted from the EOB detector 305 (step S38). When doing so, the encoder 304 is not required to perform the variable length coding for all data in one block, thereby reducing the power consumed by the encoding circuit.

As described above, the encoding circuit according to the third embodiment includes the EOB detector 305 between the DCT unit 301 and the quantizer 302. The EOB detector 305 detects the position of the rearmost non-zero quantized coefficient in a processing target block in a case where the data is diagonally scanned, and outputs the obtained value to the encoder 304 as the control signal 310. When the position of the rearmost non-zero quantized coefficient is detected by the control signal 310, the encoder 304 performs the variable length coding for the quantized coefficients up to the detected position, adds an EOB code, and pauses its operation until the next block data is inputted from the memory 303. Therefore, the power that is consumed by the encoder 304 when the variable length coding is performed can be reduced, and consequently the consumed power can be reduced in the encoding circuit without adversely affecting the picture quality.

In this third embodiment, the memory 303 is a single-port memory having two banks, while the memory 303 may be a dual-port memory having one bank.

In this third embodiment, the descriptions have been given taking the DCT process as an example of the method for frequency-converting the data that is inputted to the encoding circuit. However, any method can be employed as long as the data that is inputted to the encoding circuit is subjected to the frequency conversion. Further, when the variable length coding is performed in the encoder 304, the data is diagonally scanned while any scanning order may be selected according to the properties of the data that is inputted to the encoding circuit. In this case, it is required to change the conversion table 3056 in the EOB detector 305 to a table that converts a value of the counter 3052 (the data processing order) into the scanning order according to the data properties.

[Embodiment 4]

Hereinafter, an encoding circuit according to a fourth embodiment of the present invention will be described with reference to figures.

In this fourth embodiment, another structure in which an EOB detector is provided between a DCT unit and a quantizer like in the third embodiment will be described.

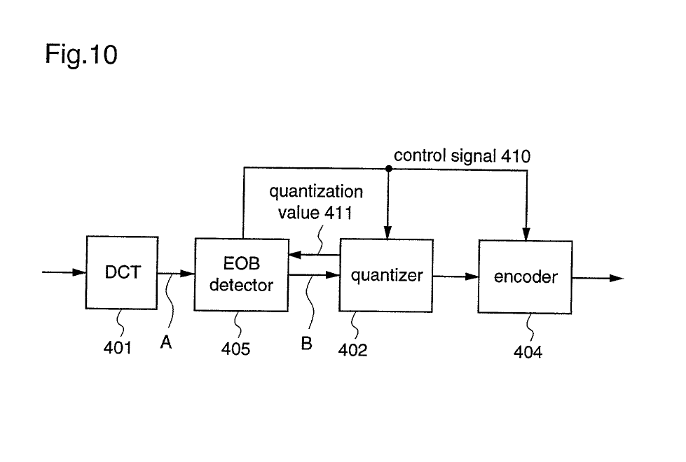

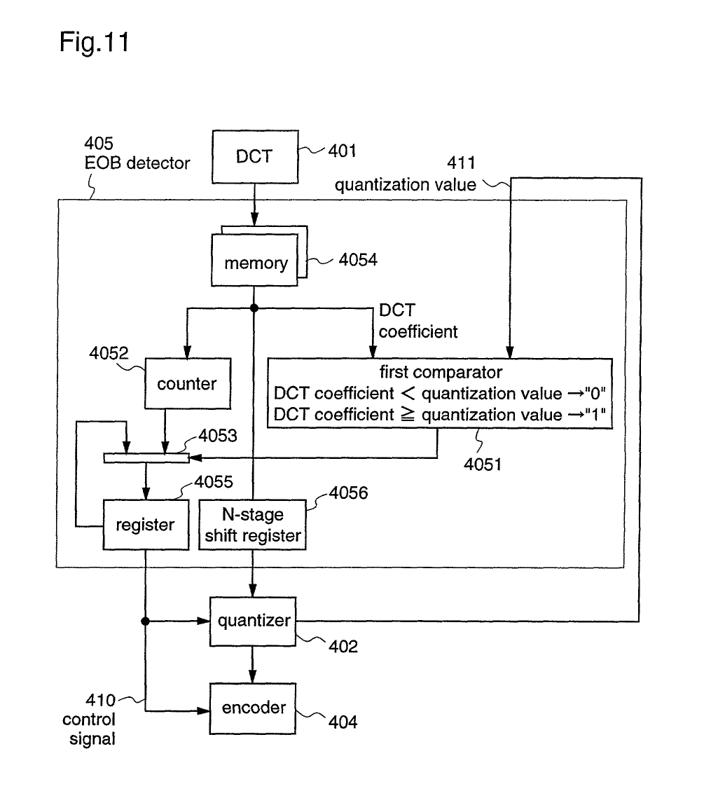

Initially, the structure of the encoding circuit according to the fourth embodiment is described with reference to FIGS. 10 and 11.

FIG. 10 is a block diagram illustrating the structure of the encoding circuit according to the fourth embodiment. FIG. 11 is a block diagram illustrating a specific structure of an EOB detector in FIG. 10.

As shown in FIG. 10, the encoding circuit of the fourth embodiment comprises a DCT unit 401 for subjecting inputted data to a DCT process, an EOB detector 405 for outputting the position of the rearmost non-zero value in a processing target block as a control signal 410, a quantizer 402 for quantizing data from the DCT unit 401, and an encoder 404 for performing a variable length coding process.

The EOB detector 405 according to the fourth embodiment comprises, as shown in FIG. 11, a memory 4054 for temporarily retaining data that is scanned in the horizontal direction and outputted from the DCT unit 401, diagonally scanning the retained data, and outputting the same; a first comparator 4051 for comparing a DCT coefficient that is read from the memory 4054 with a quantization value 411 as a divisor that is used when the data is quantized by the quantizer 402; a counter 4052 for counting data to know where the readout data is from the top of the processing target block; and a selector 4053 for selecting a value that is to be held in a register 4055 on the basis of the result of the first comparator 4051; and an N-stage shift register 4056 for retaining data of one block that is inputted from the memory 4054. Here, the memory 4054 is a single-port memory having two banks.

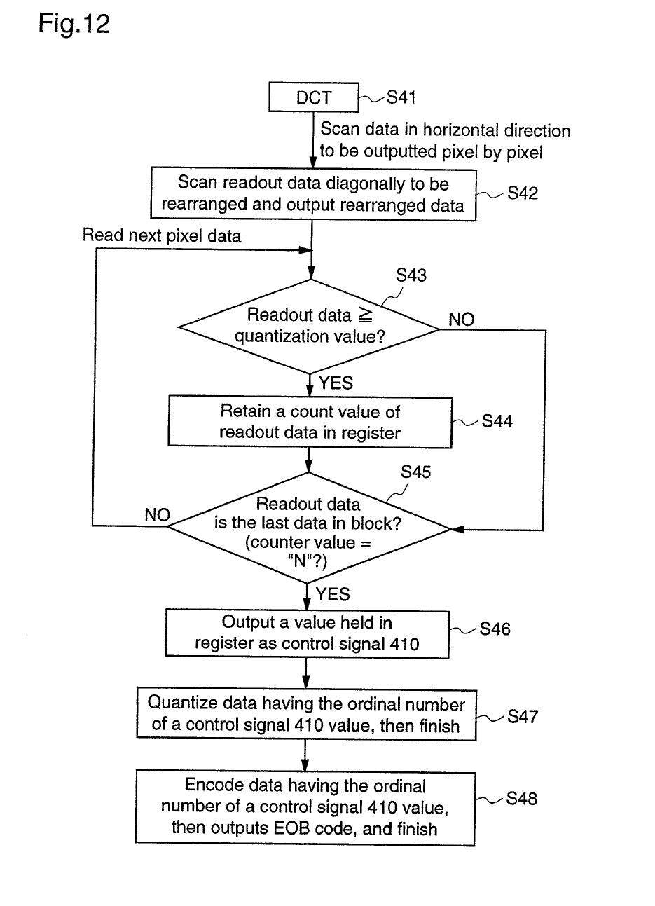

Next, the operation of the encoding circuit according to the fourth embodiment will be described with reference to FIG. 12. FIG. 12 is a flowchart for explaining the sequential operation of the encoding circuit according to the fourth embodiment.

Here, the data that is inputted to the encoding circuit is a digital video signal in which one block is composed of N pixels.

Initially, the data that is inputted to the encoding circuit is converted into DCT coefficients by the DCT unit 401 (step S41). Then, the DCT coefficients outputted from the DCT unit 401 are inputted to the EOB detector 405.

In the EOB detector 405, data of one block that is read out from the DCT unit 401 is initially written in the memory 4054 in the order as shown by the arrow in FIG. 13(a), in which data are scanned in the horizontal direction (A in FIG. 10), and then the data is outputted in the order as shown by the arrow in FIG. 13(b), in which the data are diagonally scanned (B in FIG. 10), thereby rearranging the data (step S42). The state where the data is written in the memory 4054 and the state where the data is read from the memory are shown in FIG. 14. Further, in the memory 4054, quantized coefficients of one block are stored in one bank, and then the bank switching is performed to store quantized coefficients of the next block data that is successively inputted.

Then, the data which is scanned diagonally and read from the memory 4054 is inputted to the counter 4052, the N-stage shift register 4056, and the first comparator 4051. The counter 4052 counts data to know where the readout data is from the top of the processing target block. The N-stage shift register 4056 retains the readout data. The first comparator 4051 checks whether the value of the data that is read from the memory 4054 pixel by pixel is equal to or larger than the quantization value 411 as a divisor for dividing the data in the quantization process (step S43), and outputs an obtained result to the selector 4053.

The reason why the readout data is compared with the quantization value 411 in the first comparator 4051 is the same as that described in the third embodiment.

When it is judged by the first comparator 4051 that the readout data is smaller than the quantization value 411 (when the first comparator outputs “0”), the selector 4053 selects a value that is held in the register 4055. On the other hand, when it is judged by the first comparator 4051 that the readout data is equal to or larger than the quantization value 411 (when the first comparator outputs “1”), the selector 4053 selects the value of the counter 4052 at that time, and stores the selected value in the register 4055 (step S44).

More specifically, in the fourth embodiment, the DCT coefficients which are outputted from the DCT unit 401 in the order as shown by the arrow in FIG. 13(a), in which the data are scanned in the horizontal direction, are previously rearranged in the memory 4054 in the order as shown by the arrow in FIG. 13(b), in which the data are diagonally scanned. Therefore, the value of the counter 4052 indicates the ordinal number of the readout data from the top of the block when the data is diagonally scanned. Then, the first comparator 4051 detects a DCT coefficient that is equal to or larger than the quantization value 411, the counter 4052 detects the position of the coefficient at that time, and the detected position is stored in the register 4055. Therefore, the position of the rearmost non-zero quantized coefficient in the block can be shown to the encoder 404 that diagonally scans the data to perform the variable length coding.

Then, whether or not the readout data is the last data in the processing target block is judged on the basis of whether the value of the counter 4052 is N or not, because one block is composed of N pixels (step S45). When the readout data is not the last data (the register 4055 value≠N), the above-mentioned processes are repeated. On the other hand, when the readout data is the last data in the block (the register 4055 value=N), a value that is presently held in the register 4055 is outputted to the quantizer 402 and the encoder 404 as the control signal 410 (step S46). Simultaneously, the DCT coefficients of one block stored in the N-stage shift register 4056 are outputted to the quantizer 402, as well as the values of the counter 4052 and the register 4055 are set at 1 to be initialized.

The quantizer 402 quantizes the DCT coefficients which have been diagonally scanned and inputted from the N-stage shift register 4056, pixel by pixel. At that time, the position of the rearmost non-zero coefficient in the block is detected on the basis of the control signal 410 that is outputted from the EOB detector 405, the quantization is performed for DCT coefficients up to the detected position, and then the quantizer 402 is paused until the next block data is inputted from the EOB detector 405 (step S47).

Further, the encoder 404 variable length codes the quantized coefficients of one block that is outputted from the quantizer 402. At that time, the position of the rearmost non-zero quantized coefficients in that block is detected on the basis of the control signal 410 that is outputted from the EOB detector 405, the variable length coding is performed for quantized coefficients up to the detected position, an EOB code is added to the last value that has been variable length coded, and then the encoder 404 is paused until the next block data is inputted from the quantizer 402 (step S48). When doing so, the quantizer 402 and the encoder 404 are not required to quantize or variable length code all data in the processing target block, thereby further reducing power that is consumed in the encoding circuit.

As described above, the encoding circuit according to the fourth embodiment comprises the EOB detector 405 between the DCT unit 401 and the quantizer 402. The EOB detector 405 detects the position of the rearmost non-zero quantized coefficient in a processing target block in a case where the data has been scanned diagonally, and outputs the detected value to the quantizer 402 and the encoder 404 as the control signal 410. When the rearmost non-zero quantized coefficient is detected on the basis of the control signal 410, the quantizer 402 quantizes the DCT coefficients up to the detected position and then pauses its operation. When the position of the rearmost non-zero quantized coefficient is detected on the basis of the control signal 410, the encoder 404 variable length codes the quantized coefficients up to the detected position, adds an EOB code, and pauses its operation until the next block data is inputted from the quantizer 402. Therefore, the power consumed when the quantizer 402 quantizes the coefficients or the power consumed when the encoder 404 variable length codes the quantized coefficients can be reduced, and consequently the power consumed in the encoding circuit can be reduced more without adversely affecting the picture quality.

In this fourth embodiment, the memory 4054 is a single-port memory having two banks, while the memory 4054 may be a dual-port memory having one bank.

Further, in this fourth embodiment, the descriptions have been given taking the DCT process as an example of the method for frequency-converting the data that is inputted to the encoding circuit. However, any method may be employed as long as the data that is inputted to the encoding circuit is frequency-converted. In addition, when the encoder 404 performs variable length coding, the data is diagonally scanned. However, the data may be scanned in any order and the scanning order can be selected according to the properties of the data that is inputted to the encoding circuit.

What is claimed is:

1. An encoding circuit which includes a frequency converter for frequency-converting data of a processing target block into frequency components, a quantizer for quantizing the frequency components, and an encoder for variable length coding the quantized frequency components in a predetermined scanning order, including:
an EOB detector for detecting a position of a rearmost non-zero quantized frequency component in the processing target block in the predetermined scanning order, and outputting the detected position as a control signal to the encoder; and
said encoder variable length coding the quantized frequency components up to the position in the predetermined scanning order, indicated by the control signal, adding an EOB code that indicates an end of effective components, and pausing the variable length coding process.

2. The encoding circuit of claim 1 wherein
the EOB detector is provided between a memory for temporarily retaining the quantized frequency components of the processing target block from the quantizer and outputting the retained frequency components in the predetermined scanning order, and the encoder, and
said EOB detector includes:
a counter for detecting a position of the quantized frequency component that is inputted from the memory;
a comparator for comparing the quantized frequency component with zero;
a buffer for storing values of the quantized frequency components; and
a register for retaining a position of a non-zero quantized frequency component on the basis of a result of the comparator.

3. The encoding circuit of claim 1 wherein
the EOB detector is provided between the quantizer and a memory for temporarily retaining the quantized frequency components of the processing target block from the quantizer, and
said EOB detector includes:
a counter for detecting a position of the quantized frequency component that is inputted from the quantizer;
a first comparator for comparing the quantized frequency component with zero;
a buffer for storing values of the quantized frequency components;
a conversion table for converting the value of the counter into an ordinal number of the quantized frequency component in the predetermined scanning order;
a register for retaining a position of a non-zero quantized frequency component in the predetermined scanning order on the basis of a result of the first comparator; and
a second comparator for comparing the position that is retained in the register, with the position of the rearmost non-zero quantized frequency component in the processing target block in the predetermined scanning order.

4. The encoding circuit of claim 1 wherein
the EOB detector is provided between the frequency converter and the quantizer, and
said EOB detector includes:
a counter for detecting a position of a frequency component that is inputted from the frequency converter;
a first comparator for comparing the frequency component, with a quantization value as a divisor for dividing the frequency component in the quantizer;
a conversion table for converting the value of the counter into an ordinal number of the frequency component in the predetermined scanning order;
a register for retaining a position of a non-zero quantized frequency component in the predetermined scanning order on the basis of a result of the first comparator; and
a second comparator for comparing the position retained in the register, with the position of the rearmost non-zero quantized frequency component in the processing target block in the predetermined scanning order.

5. An encoding circuit that includes a frequency converter for frequency-converting data of a processing target block into frequency components, a quantizer for quantizing the frequency components, and an encoder for variable length coding the quantized frequency components in a predetermined scanning order, comprising:
an EOB detector for detecting a position of a rearmost non-zero quantized frequency component in the processing target block in the predetermined scanning order, and outputting the detected position as a control signal to the quantizer and the encoder;
said quantizer quantizing the frequency components up to the position in the predetermined scanning order, indicated by the control signal, and pausing the quantization process; and
said encoder variable length coding the quantized frequency components up to the position in the predetermined scanning order, indicated by the control signal, adding an EOB code that indicates an end of effective components, and pausing the variable length coding process.

6. The encoding circuit of claim 5 wherein
the EOB detector is provided between the frequency converter and the quantizer, and
said EOB detector includes:
a memory for temporarily retaining the frequency components of the processing target block from the frequency converter, and outputting the retained frequency components in the predetermined scanning order;
a counter for detecting a position of the frequency component that is inputted from the memory in the predetermined scanning order;
a first comparator for comparing the frequency component, with a quantization value as a divisor for dividing the frequency component in the quantizer;
a buffer for storing values of the frequency components; and
a register for retaining a position of a non-zero quantized frequency component in the predetermined scanning order on the basis of a result of the first comparator.

7. An encoding method comprising:
a frequency conversion step of frequency-converting data of a processing target block into frequency components;
a quantization step of quantizing the frequency components;
an EOB detection step of judging whether the quantized frequency component is zero or not, and detecting a position of a rearmost non-zero quantized frequency component in the processing target block in a predetermined scanning order; and
an encoding step of variable length coding the quantized frequency components up to the position in the predetermined scanning order, detected in the EOB detection step, adding an EOB code that indicates an end of effective components, and pausing the variable length coding process.

8. An encoding method comprising:
a frequency conversion step of frequency-converting data of a processing target data into frequency components;
an EOB detection step of comparing the frequency components with a quantization value as a divisor for dividing the frequency components in a quantization process, and detecting a position of a rearmost non-zero quantized frequency component in the processing target block in a predetermined scanning order;
a quantization step of quantizing the frequency components; and
an encoding step of variable length coding the quantized frequency components up to the position in the predetermined scanning order, detected in the EOB detection step, adding an EOB code that indicates an end of effective components, and pausing the variable length coding process.

9. An encoding method comprising:
a frequency conversion step of frequency-converting data of a processing target block into frequency components;
an EOB detection step of comparing the frequency components with a quantization value as a divisor for dividing the frequency components in a quantization process, and detecting a position of a rearmost non-zero quantized frequency component in the processing target block in a predetermined scanning order;
a quantization step of quantizing the frequency components up to the position in the predetermined order, detected in the EOB detection step, and pausing the quantization process; and
an encoding step of variable length coding the quantized frequency components up to the position in the predetermined scanning order, adding an EOB code that indicates an end of effective components, and pausing the variable length coding process.

10. An encoding program for making a computer implement a process of frequency-converting data of a processing target block, quantizing frequency components, and variable length coding the quantized frequency components in a predetermined scanning order,
said process comprising:
a frequency conversion step of frequency-converting the data of the processing target block into frequency components;
a quantization step of quantizing the frequency components;
an EOB detection step of judging whether the quantized frequency components are zero or not, and detecting a position of a rearmost non-zero quantized frequency component in the processing target block in the predetermined scanning order; and
an encoding step of variable length coding the quantized frequency components up to the position in the predetermined scanning order, detected in the EOB detection step, adding an EOB code that indicates an end of effective components, and pausing the variable length coding process.

11. An encoding program for making a computer implement a process of frequency-converting data of a processing target block, quantizing frequency components, and variable length coding the quantized frequency components in a predetermined scanning order,
said process comprising:
a frequency conversion step of frequency-converting the data of the processing target block into frequency components;
an EOB detection step of comparing the frequency components with a quantization value as a divisor for dividing the frequency components in a quantization process, and detecting a position of a rearmost non-zero quantized frequency component in the processing target block in the predetermined scanning order;
a quantization step of quantizing the frequency components; and
an encoding step of variable length coding the quantized frequency components up to the position in the predetermined scanning order, detected in the EOB detection step, adding an EOB code that indicates an end of effective components, and pausing the variable length coding process.

12. An encoding program for making a computer implement a process of frequency-converting data of a processing target block, quantizing frequency components, and variable length coding the quantized frequency components in a predetermined scanning order,
said process comprising:
a frequency conversion step of frequency-converting the data of the processing target block into frequency components;
an EOB detection step of comparing the frequency components with a quantization value as a divisor for dividing the frequency components in a quantization process, and detecting a position of a rearmost non-zero quantized frequency component in the processing target block in the predetermined scanning order;
a quantization step of quantizing the frequency components up to the position in the predetermined scanning order, detected in the EOB detection step, and pausing the quantization process; and
an encoding step of variable length coding the quantized frequency components up to the position in the predetermined scanning order, adding an EOB code that indicates an end of effective components, and pausing the variable length coding process.
